(19) United States
(12) Patent Application Publication
(10) Pub. No.: US 2009/0030141 A1
(43) Pub. Date: Jan. 29, 2009

(54) POLY(ARYLENE ETHER) COMPOSITION, METHOD, AND ARTICLE

(76) Inventors: Kim Gene Balfour, Delanson, NY (US); Scott Michael Fisher, Delmar, NY (US); Hua Guo, Selkirk, NY (US); Vijay Mhetar, Slingerlands, NY (US)

Correspondence Address: CANTOR COLBURN LLP - SABIC (NORYL), 20 Church Street, 22nd Floor, Hartford, CT, 06103, US

(21) Appl. No.: 11/781,571

(22) Filed: Jul. 23, 2007

(51) Int. Cl. C08L 53/00

(52) U.S. Cl. 524/578; 525/92 F; 525/92 R

(57) ABSTRACT

The invention provides a composition including a crosslinked styrenic block copolymer, a poly(arylene ether), and a non-polyolefin crystalline or semi-crystalline resin. The composition exhibits an improved balance of stiffness, ductility, and heat resistance. The composition can be prepared by a process that includes melt-kneading the poly(arylene ether), an acid functionalized styrenic block copolymer, an amine crosslinking agent, and a non-polyolefin crystalline or semi-crystalline resin.

### BACKGROUND OF THE INVENTION

The present invention relates to a thermoplastic resin composition. More particularly, the present invention is concerned with a thermoplastic resin composition comprising a poly(arylene ether), a non-polyolefin crystalline or semi-crystalline resin, and a crosslinked styrenic block copolymer. This composition exhibits an excellent balance of heat distortion resistance, impact resistance, and stiffness.

A thermoplastic resin composition comprising a poly(arylene ether) resin, a polyamide and a styrenic rubber is known in the art for its properties such as ductility, impact resistance, heat distortion temperature, softening temperature. Unfortunately, the composition does not have a desired balance of ductility and heat distortion temperature, which results in an improvement in ductility and impact resistance while at the same time decrease in the heat distortion temperature or Vicat softening temperature.

There remains a need for a poly(arylene ether) composition with an improved balance of ductility or impact resistance and heat distortion temperature or Vicat softening temperature.

### BRIEF DESCRIPTION OF THE INVENTION

In the course of extensive research, the present inventors unexpectedly discovered that an excellent balance among ductility, stiffness, and heat resistance is exhibited by a thermoplastic composition comprising a crosslinked styrenic block copolymer; a poly(arylene ether); and a non-polyolefin crystalline or semi-crystalline resin.

One embodiment is a thermoplastic composition comprising a crosslinked styrenic block copolymer; a poly(arylene ether); and a non-polyolefin crystalline or semi-crystalline resin.

Another embodiment is a thermoplastic composition comprising a crosslinked styrenic block copolymer; a poly(arylene ether); and a non-polyolefin crystalline or semi-crystalline resin comprising a polyamide, a polyester and a combination thereof.

Another embodiment is a thermoplastic composition comprising a crosslinked styrenic block copolymer; a poly(arylene ether); and a non-polyolefin crystalline or semi-crystalline resin; wherein the crosslinked styrenic block copolymer is partially crosslinked styrenic block copolymer.

Another embodiment is a thermoplastic composition comprising a crosslinked styrenic block copolymer; a poly(arylene ether); and a non-polyolefin crystalline or semi-crystalline resin; wherein the crosslinked styrenic block copolymer is a partially crosslinked styrenic block copolymer obtained on melt-kneading a crosslinking agent and an acid-functionalized styrenic block copolymer comprising (A) at least one block derived from an alkenyl aromatic monomer and (B) at least one block derived from a conjugated diene.

Another embodiment is a thermoplastic composition comprising a crosslinked styrenic block copolymer; a poly(arylene ether) comprising 2,6-dimethyl-1,4-phenylene ether units, 2,3,6-trimethyl-1,4-phenylene ether units, or a combination thereof; and a non-polyolefin crystalline or semi-crystalline resin comprising a polyamide, a polyester or a combination thereof; wherein the crosslinked styrenic block copolymer is a partially crosslinked styrenic block copolymer obtained on melt-kneading maleic anhydride or fumaric acid-functionalized styrenic block copolymer comprising (A) at least one block derived from an alkenyl aromatic monomer and (B) at least one block derived from a conjugated diene which is at least partially hydrogenated, and a crosslinking agent selected from the group consisting of an amine crosslinking compound and a peroxide compound.

Another embodiment is a thermoplastic composition comprising a poly(arylene ether) comprising 2,6-dimethyl-1,4-phenylene ether units, 2,3,6-trimethyl-1,4-phenylene ether units, or a combination thereof; a non-polyolefin crystalline or semi-crystalline resin comprising a polyamide, a polyester, or a combination thereof; and a partially crosslinked styrenic block copolymer obtained on melt-kneading a maleic anhydride-functionalized block copolymer selected from the group consisting of polystyrene-poly(ethylene-butylene)-polystyrene triblock copolymer, polystyrene-poly(ethylene-propylene)-polystyrene triblock copolymer, a block copolymer containing at least one block derived from a conjugated diene, and mixtures thereof; and an aliphatic polyamine crosslinking agent comprising polyethylenimine, hexamethylenediamine, hexamethylenediamine carbamate, aminosilane, or tetramethylenepentamine.

Another embodiment is a thermoplastic composition comprising a crosslinked styrenic block copolymer; a poly(arylene ether); a non-polyolefin crystalline or semi-crystalline resin; and a compatibilizing agent.

Another embodiment is a thermoplastic composition comprising a crosslinked styrenic block copolymer; and a compatibilized poly(arylene ether)/non-polyolefin crystalline or semi-crystalline resin.

Another embodiment is a thermoplastic composition comprising a continuous phase and one or more dispersed phases, wherein the continuous phase comprises the non-polyolefin crystalline or semi-crystalline resin; and the dispersed phases comprise a poly(arylene ether); and wherein the crosslinked styrenic block copolymer is micro-dispersed in the continuous phase, the dispersed phases, or both.

Another embodiment is a thermoplastic composition comprising 5 to 60 parts by weight of a crosslinked styrenic block copolymer; 5 to 65 parts by weight of a poly(arylene ether); and 35 to 95 parts by weight of a non-polyolefin crystalline or semi-crystalline resin; wherein all parts by weight are based on 100 parts by weight total of the poly(arylene ether) and the non-polyolefin crystalline or semi-crystalline resin.

Another embodiment is a thermoplastic composition comprising 5 to 60 parts by weight of a crosslinked styrenic block copolymer; 40 to 95 parts by weight of a compatibilized poly(arylene ether)/non-polyolefin crystalline or semi-crystalline resin; wherein all parts by weight are based on 100 parts by weight total of the poly(arylene ether) and the non-polyolefin crystalline or semi-crystalline resin.

Another embodiment is a thermoplastic composition comprising a continuous phase comprising a non-polyolefin crystalline or semi-crystalline resin; and a dispersed phase comprising a crosslinked styrenic block copolymer.

Another embodiment is a thermoplastic composition comprising a continuous phase comprising the non-polyolefin crystalline or semi-crystalline resin; and a dispersed phase comprising the poly(arylene ether); wherein the crosslinked styrenic block copolymer is micro-dispersed in the continuous phase, the dispersed phase, or both.

One embodiment is a method of preparing a thermoplastic composition comprising a crosslinked styrenic block copolymer, a poly(arylene ether), and a non-polyolefin crystalline or semi-crystalline resin, comprising: melt-kneading the crosslinked styrenic block copolymer, the poly(arylene ether), and the non-polyolefin crystalline or semi-crystalline resin.

Another embodiment is a method of preparing a thermoplastic composition comprising a crosslinked styrenic block copolymer, a poly(arylene ether), and a non-polyolefin crystalline or semi-crystalline resin, comprising: melt-kneading an acid-functionalized styrenic block copolymer, an amine or peroxide crosslinking agent, and a part of poly(arylene ether) to obtain a masterbatch; and blending the masterbatch with the non-polyolefin crystalline or semi-crystalline resin and remaining poly(arylene ether).

Another embodiment is a method of preparing a thermoplastic composition comprising a crosslinked styrenic block copolymer, a poly(arylene ether), and a non-polyolefin crystalline or semi-crystalline resin, comprising: making a masterbatch by melt-kneading the crosslinked styrenic block copolymer and a part of the poly(arylene ether); and blending the masterbatch, the remaining poly(arylene ether), and the non-polyolefin crystalline or semi-crystalline resin.

Another embodiment is a method of preparing a thermoplastic composition comprising a crosslinked styrenic block copolymer, a poly(arylene ether), and a non-polyolefin crystalline or semi-crystalline resin, comprising: making a masterbatch by melt-kneading the crosslinked styrenic block copolymer and a part of the poly(arylene ether) in an amount of 15 to 70 parts by weight based on the total of the poly(arylene ether); and blending the masterbatch, the remaining poly(arylene ether), the non-polyolefin crystalline or semi-crystalline resin, and additional components if present.

These and other embodiments are described in detail below.

### DETAILED DESCRIPTION OF THE INVENTION

In the present invention, one embodiment is a thermoplastic composition comprising a crosslinked styrenic block copolymer, a poly(arylene ether), and a non-polyolefin crystalline or semi-crystalline resin.

As used herein, “non-polyolefin crystalline or semi-crystalline resins” means crystalline or semi-crystalline resins made from poly-condensation excluding polyolefin crystalline or semi-crystalline resins. Typical non-polyolefin crystalline or semi-crystalline resins are those made from poly-condensation reaction. Preferably, the non-polyolefin crystalline or semi-crystalline resins include polyesters, polyamides or a combination thereof.

In one embodiment, a thermoplastic composition comprises a crosslinked styrenic block copolymer, a poly(arylene ether), and a polyamide.

In another embodiment, a thermoplastic composition comprises a crosslinked styrenic block copolymer, a poly(arylene ether), and a polyester.

Preferred crystalline or semi-crystalline polyesters comprise condensation products of an aliphatic or cycloaliphatic diol, or chemical equivalents; and an aliphatic or aromatic dicarboxylic acid, or chemical equivalents. The polyesters may be formed from mixtures of aliphatic diacids and aliphatic diols.

Preferred polyesters are derived from an aliphatic diol and an aromatic dicarboxylic acid and comprise repeating units of the following general formula:

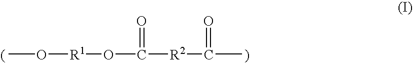

wherein the polyester is a condensation product where R¹ is the residue of an aryl, alkane or cycloalkane-containing diol or chemical equivalent thereof, and R² is the decarboxylated residue derived from an aryl, aliphatic or cycloalkane containing diacid or chemical equivalent thereof. Preferably, R¹ and R² are each independently a divalent C₁-C₂₀ aliphatic radical, a C₂-C₁₂ cycloaliphatic alkyl radical, or a C₆-C₂₄ aromatic radical.

The polyester resins are typically obtained through the condensation or ester interchange polymerization of the diol or diol equivalent component with the dicarboxylic acid or dicarboxylic acid chemical equivalent component.

Examples of aromatic dicarboxylic acids are isophthalic or terephthalic acid, 1,2-di(p-carboxyphenyl)ethane, 4,4′-dicarboxydiphenyl ether, 4,4′-bisbenzoic acid and mixtures thereof. All of these acids contain at least one aromatic nucleus. Acids containing fused rings can also be present, such as in 1,4-1,5- or 2,6-naphthalene dicarboxylic acids. The preferred dicarboxylic acids are terephthalic acid, isophthalic acid, naphthalene dicarboxylic acid, or mixtures thereof.

The preferred polyesters are poly(ethylene terephthalate) (“PET”), poly(1,4-butylene terephthalate), (“PBT”), and poly(propylene terephthalate) (“PPT”). PBT is preferred for fast crystallization. PET is desirable to use to obtain enhanced surface properties especially in injection molded parts.

The polyamide resins useful in the practice of the present invention are a generic family of resins known as nylons, characterized by the presence of an amide group (—C(O)NH—). Nylon-6 and nylon-6,6 are the generally preferred polyamides and are available from a variety of commercial sources. Other polyamides, however, such as nylon-4,6, nylon-12, nylon-6,10, nylon 6,9, nylon 6/6T and nylon 6,6/6T with triamine contents below about 0.5 parts by weight, as well as others, such as the amorphous nylons may be useful for the invention. Mixtures of various polyamides as well as various polyamide copolymers, are also useful. The most preferred polyamide for the blends of the present invention is nylon 6,6.

Typical examples of polyamides (nylons) useful in the present compositions include, for example, nylon 4,6, nylon 6, nylon 6,6, nylon 11, nylon 12, nylon 6,3, nylon 6,4, nylon 6,10, nylon 6,9, nylon 6/6T, nylon 6,6/6T and nylon 6,12, as well as polyamides prepared from terephthalic acid and/or isophthalic acid and trimethyl hexamethylene diamine, polyamides prepared from adipic acid and meta xylylenediamines, polyamides prepared from adipic acid and/or azelaic acid and 2,2-bis-(p-aminocyclohexyl)propane, semi-crystalline polyamides resulting from combinations of terephthalic and/or isophthalic and/or adipic acids with hexamethylene diamine, semi-crystalline polyamides prepared from terephthalic and/or isophthalic acids and hexamethylene diamine and 2-methyl pentamethylene diamine, and polyamides prepared from terephthalic acid and 4,4′-diamino-dicyclohexylmethane. Mixtures and/or copolymers of two or more of the foregoing polyamides may also be used.

It is also understood that use of the term “polyamide” includes the toughened or super tough polyamides. Super tough polyamides or super tough nylons, as they are more commonly known, are available commercially, e.g., from E.I. duPont under the tradename ZYTEL® ST, or may be prepared according to methods described in, for example, U.S. Pat. Nos. 4,174,358 to Epstein, 4,474,927 to Novak, 4,346,194 to Roura, and 4,251,644 to Joffrion. These super tough nylons are prepared by blending one or more polyamides with one or more polymeric or copolymeric elastomeric toughening agents. Suitable toughening agents are disclosed in the above-identified U.S. patents, as well as in U.S. Pat. Nos. 3,884,882 to Caywood, Jr., and 4,147,740 to Swiger; and Gallucci et al., “Preparation and Reactions of Epoxy-Modified Polyethylene”, J. Appl. Poly. Sci., Vol. 27, pp. 425-437 (1982). Typically, these elastomeric polymers and copolymers may be straight chain or branched as well as graft polymers and copolymers, including core-shell graft copolymers, and they are characterized as having incorporated therein either by copolymerization or by grafting on the preformed polymer, a monomer having functional and/or active or highly polar groupings capable of interacting with or adhering to the polyamide matrix so as to enhance the toughness of the polyamide polymer.

The polyamides can be obtained by a number of well known processes such as those described in U.S. Pat. Nos. 2,071,250; 2,071,251; 2,130,523; 2,130,948; 2,241,322; 2,312,966; and 2,512,606. Nylon-6, for example, is a polymerization product of caprolactam. Nylon-6,6 is a condensation product of adipic acid and 1,6-diaminohexane. Likewise, nylon 4,6 is a condensation product between adipic acid and 1,4-diaminobutane. Besides adipic acid, other useful diacids for the preparation of nylons include azelaic acid, sebacic acid, dodecane diacid, as well as terephthalic and isophthalic acids, and the like. Other useful diamines include m-xylyene diamine, di-(4-aminophenyl)methane, di-(4-aminocyclohexyl)methane; 2,2-di-(4-aminophenyl)propane, 2,2-di-(4-aminocyclohexyl)propane, among others. Copolymers of caprolactam with diacids and diamines are also useful.

Polyamides having a viscosity of up to about 400 ml/g can be used, with a viscosity of about 90 to about 350 ml/g preferred, and about 110 to about 240 ml/g especially preferred, as measured in a 0.5 wt % solution in 96 wt % sulfuric acid in accordance with ISO 307.

The composition may comprise the polyamide in an amount of about 30 to about 65 parts by weight, based on the total weight of the composition. Within this range, the polyamide amount may preferably be at least about 35 parts by weight, more preferably at least about 40 parts by weight, still more preferably at least about 45 parts by weight. Also within this range, the polyamide amount may preferably be up to about 55 parts by weight, more preferably up to about 50 parts by weight.

In a preferred embodiment, the polyamide comprises nylon 6, nylon 6,6, or a combination thereof. In this embodiment, the nylon 6 amount may be about 3 parts by weight to about 17 parts by weight, based on the total weight of the composition. Within this range, the nylon 6 amount may preferably be at least about 7 parts by weight. Also within this range, the nylon 6 amount may preferably be up to about 13 parts by weight. In this embodiment, the nylon 6,6 amount may be about 25 parts by weight to about 51 parts by weight. Within this range, the nylon 6,6 amount may preferably be at least about 32 parts by weight, more preferably at least about 35 parts by weight. Also within this range, the nylon 6,6 amount may preferably be up to about 44 parts by weight, more preferably up to about 41 parts by weight.

In general, it is desirable to have the nylon 6 present in an amount greater than or equal to about 3, preferably greater than or equal to about 8 parts by weight, while the nylon 6,6 is present in an amount greater than or equal to about 25 preferably greater than or equal to about 35 parts by weight based on the total weight of the composition. Similarly it is desirable to have the nylon 6 present in an amount of less than or equal to about 15, preferably less than or equal to about 12 parts by weight, while the nylon 6,6 is present in an amount of less than or equal to about 50, preferably less than or equal to about 40 parts by weight, based on the total weight of the composition.

The composition comprises the non-polyolefin crystalline or semi-crystalline resin in an amount of 35 to 95 parts by weight. Within this range, the non-polyolefin crystalline or semi-crystalline resin may be present in an amount greater than or equal to 40 parts by weight, or, more specifically, in an amount greater than or equal to 45 parts by weight, or, even more specifically, in an amount greater than or equal to 48 parts by weight. Also within this range the non-polyolefin crystalline or semi-crystalline resin may be present in an amount less than or equal to 90 parts by weight, or, more specifically, less than or equal to 75 parts by weight, or, even more specifically, less than or equal to 60 parts by weight. All parts by weight are based on 100 parts by weight total of the poly(arylene ether) and the non-polyolefin crystalline or semi-crystalline resin.

In one embodiment, a thermoplastic composition comprises a continuous phase comprising a non-polyolefin crystalline or semicrystalline resin and a dispersed phase comprising a poly(arylene ether), wherein a crosslinked styrenic block copolymer component is micro-dispersed in the continuous phase, the dispersed phase, or both.

In one embodiment, a thermoplastic composition comprises a continuous phase comprising a non-polyolefin crystalline or semi-crystalline resin, and a dispersed phase comprising a crosslinked styrenic block copolymer.

In one embodiment, a thermoplastic composition comprises a continuous phase comprising a polyamide and a dispersed phase comprising a poly(arylene ether), wherein a crosslinked styrenic block copolymer is micro-dispersed in the continuous phase, the dispersed phase, or both.

In one embodiment, a thermoplastic composition comprises a continuous phase comprising a polyester and a dispersed phase comprising a poly(arylene ether), wherein a crosslinked styrenic block copolymer is micro-dispersed in the continuous phase, the dispersed phase, or both.

The crosslinked styrenic block copolymer useful in the present invention is a reaction product of a styrenic block copolymer and a crosslinking agent.

In some embodiments, the composition comprises a crosslinked block copolymer of an alkenyl aromatic monomer and a conjugated diene, wherein the crosslinked block copolymer comprises about 30 to about 90 weight percent, preferably 30 to about 60 weight percent of repeating units derived from the alkenyl aromatic monomer.

As used herein, “styrenic block copolymer” refers to those copolymers which comprise (A) at least one block derived from an alkenyl aromatic compound and (B) at least one block derived from a conjugated diene. The arrangement of blocks (A) and (B) includes a linear structure and a so-called radial teleblock structure having branched chains.

Preferred of these structures are linear structures embracing diblock (A-B block), triblock (A-B-A block or B-A-B block), tetrablock (A-B-A-B block), and pentablock (A-B-A-B-A block or B-A-B-A-B block) structures as well as linear structures containing 6 or more blocks in total of A and B. More preferred are diblock, triblock, and tetrablock structures, with the A-B diblock and A-B-A triblock structures being particularly preferred.

The alkenyl aromatic compound providing the block (A) is represented by formula:

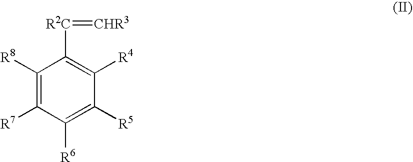

wherein R² and R³ each independently represent a hydrogen atom, a C₁-C₈ alkyl group, a C₂-C₈ alkenyl group, or the like; R⁴ and R⁸ each independently represent a hydrogen atom, a C₁-C₈ alkyl group, or the like; and R⁵-R⁷ each independently represent a hydrogen atom, a C₁-C₈ allyl group, a C₂-C₈ alkenyl group, or the like, or R⁴ and R⁵ are taken together with the central aromatic ring to form a naphthyl group, or R⁵ and R⁶ are taken together with the central aromatic ring to form a naphthyl group.

Specific examples of the alkenyl aromatic compounds include styrene, p-methylstyrene, alpha-methylstyrene, vinylxylenes, vinyltoluenes, vinylnaphthalenes, divinylbenzenes, and the like, and combinations comprising at least one of the foregoing alkenyl aromatic compounds. Of these, styrene, alpha-methylstyrene, p-methylstyrene, vinyltoluenes, and vinylxylenes are preferred, with styrene being more preferred.

The conjugated diene used to prepare the crosslinked high-styrene block copolymer may be a C₄-C₂₀ conjugated diene. Suitable conjugated dienes include, for example, 1,3-butadiene, 2-methyl-1,3-butadiene, 2-chloro-1,3-butadiene, 2,3-dimethyl-1,3-butadiene, 1,3-pentadiene, 1,3-hexadiene, and the like, and combinations thereof. In one embodiment, the conjugated diene is 1,3-butadiene, 2-methyl-1,3-butadiene, or a combination thereof.

In some embodiments, the crosslinked styrenic block copolymer is a crosslinked copolymer comprising (A) at least one block derived from an alkenyl aromatic compound and (B) at least one block derived from a conjugated diene.

In some embodiments, the acid-functionalized block copolymer is a maleic anhydride-functionalized linear block copolymer or radial teleblock copolymer of styrene and a conjugated diene selected from the group consisting of butadiene, isoprene, and combinations thereof, wherein the an acid-functionalized block copolymer has a styrene content of about 10 to about 60 weight percent. Within the scope, the styrene content is preferably greater than about 20, more preferably greater than about 30 weight percent. Within the scope, the styrene content is preferably less than about 50, more preferably less than about 40 weight percent.

In some embodiments, the acid-functionalized block copolymer is a maleic anhydride or fumaric acid-functionalized polystyrene-poly(ethylene-butylene)-polystyrene (SEBS) triblock copolymer having a styrene content of about 10 to about 60 weight percent, preferably about 10 to about 50 weight percent or a maleic anhydride or fumaric acid-functionalized polystyrene-poly(ethylene-butylene) (SEB) diblock copolymer having a styrene content of about 10 to about 90 weight percent, preferably about 30 to about 70 weight percent.

There is no particular limitation on the method used to crosslink a styrenic block copolymer. Any agent known to form chemical crosslinks with the acid-functionalized block copolymer may be used in the invention.

In one embodiment, the crosslinking agent comprises amines. Preferably, di- or polyamines are used to crosslink with acid functional groups in the acid-functionalized block copolymer. More preferably, the amine crosslinking agent is a multi-functional amine comprising more than two amine groups. For example, the crosslinked styrenic block copolymer may comprise the reaction product of the acid-functionalized block copolymer and a multi-functional amine. The amine crosslinking agent useful in the present invention may comprise any other functional groups that are inert in the crosslinking reaction, such as silyl group. The styrenic block copolymer may be crosslinked in the presence of the poly(arylene ether) to make a master batch.

In one embodiment, amines for the crosslinking of polymers containing acid anhydride groups are aliphatic, alicyclic, heterocyclic or aromatic, primary or secondary amines.

Examples of suitable amines according to the invention are: ethylenediamine, propanediamine, butanediamine, pentanediamine, hexanediamine, isomers of the above amines, 1,2- and 1,4-diaminocyclohexane, diethylene-triamine, triethylene-tetramine, tetraethylene-pentamine, N-aminoethyl-3-aminopropyltrialkoxysilane, triamino-functional propyltrialkoxysilane, piperazine, aminoethyl-piperazine, di-aminoethyl-piperazine, xylylenediamine, isophoronediamine, 3,3′-dimethyl-4,4′diaminodicyclohexyl-methane, 4,4′-diaminocyclohexylmethane, 4,4′-diamino-diphenylmethane, 1,4-diamino-benzanilide.

In some embodiments, the amine crosslinking agent comprises an aminosilane having the formula

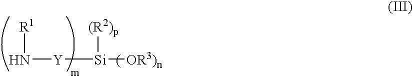

wherein each occurrence of R¹ is independently hydrogen, C₁-C₁₂ hydrocarbyl, or C₁-C₁₂ hydrocarbylene covalently bound to Y; each occurrence of R² and R³ is independently C₁-C₁₂ hydrocarbyl; each occurrence of Y is independently C₁-C₁₂ hydrocarbylene or hydrocarbyleneoxy wherein the hydrocarbylene or hydrocarbyleneoxy group may further comprise one or more catenary ether oxygen atoms; m is 1, 2, 3, or 4; n is 0, 1, 2, or 3; and p is 0, 1, 2, or 3; with the proviso that the sum of m and n and p is 4. Suitable aminosilanes include, for example, 3-aminopropyltrimethoxysilane, 3-aminopropyldimethylmethoxysilane, 3-aminopropylmethyldimethoxysilane, 3-(aminopropyl)ethyldimethoxysilane, 3-aminopropyltriethoxysilane, 3-aminopropyldimethylethoxysilane, 3-aminopropylphenyldimethoxysilane, 2-aminoethyltriethoxysilane, 4-aminobutyltriethoxysilane, 4-aminobutyldimethoxysilane, 4-aminobutylmethyldimethoxysilane, 4-(trimethoxysilyl)-2-butanamine, 3-[diethoxy(hexyloxy)silyl]-1-propanamine, 3-[tris(pentyloxy)silyl]-1-propanamine, 3-[tris(2,2,2-trifluoroethoxy)silyl]-1-propanamine, 3-[tris[2-(2-phenoxyethoxy)ethoxy]silyl]-1-propanamine, 3-[tris[(2-ethylhexyl)oxy]silyl]-1-propanamine, 3-[tris(hexyloxy)silyl]-1-propanamine, 3-triisopropoxysilylpropylamine, 3-[tris(3-methylbutoxy)silyl]-1-propanamine, 3-[tris(2-ethoxyethoxy)silyl]-1-propanamine, 3-[bis(1,1-dimethylethoxy)methoxysilyl]-1-propanamine, 3-[(1,1-dimethylethoxy)diethoxysilyl]-1-propanamine, 3-[(1,1-dimethylethoxy)dimethoxysilyl]-1-propanamine, 3-(trimethoxysilyl)-1-pentanamine, 10,10-bis[2-(2-ethoxyethoxy)ethoxy]-3,6,9-trioxa-10-silatridecan-13-amine, 13,13-bis[2-[2-(2-ethoxyethoxy)ethoxy]ethoxy]-3,6,9,12-tetraoxa-13-silahexa-decan-16-amine, 4-amino-3,3-dimethylbutyltrimethoxysilane, 4-amino-3,3-dimethylbutyltriethoxysilane, and the like, and mixtures thereof.

In one embodiment, the aminosilane is 3-aminopropyltriethoxysilane (Chemical Abstracts Service (CAS) Registry No. 919-30-2). Methods for preparing aminosilanes are known in the art, and many aminosilanes are commercially available.

The amines are used in an amount effective to crosslink the block copolymer. The amount of the amines is typically about 1 to about 50 parts by weight per 100 parts by weight of the uncrosslinked block copolymer. Within this range, the amount may be at least about 2 parts by weight, or at least about 5 parts by weight. Also within this range, the amount may be up to about 35 parts by weight, or up to about 20 parts by weight.

In some embodiments, the crosslinking agent may be, for example, sulfur, a sulfur donor compound, a peroxide compound, a hydroperoxide compound, an azo compound, or a combination thereof for the styrenic block copolymers comprising (A) at least one block derived from an alkenyl aromatic monomer and (B) at least one block derived from a conjugated diene, which is at least partially hydrogenated. In some embodiments, the crosslinking agent is a peroxide compound.

In some embodiments, the crosslinked styrenic block copolymer is prepared by melt-kneading an acid-functionalized styrenic block copolymer of an alkenyl aromatic monomer and a conjugated diene; and an amine crosslinking agent.

The crosslinked styrenic block copolymer used in some embodiments is a blend obtained on melt-kneading a block copolymer comprising (A) at least one block derived from an alkenyl aromatic monomer and (B) at least one block derived from a conjugated diene; and a free radical initiator type crosslinking agent. In one embodiment, the crosslinked styrenic block copolymer comprises a reaction product of styrenic block copolymer and a peroxide compound.

The acid-functionalized block copolymer is prepared from an unfunctionalized block copolymer precursor. As used herein, “block copolymer” refers to a single block copolymer or a combination of block copolymers. The block copolymer comprises at least one block (A) comprising repeating aryl allylene units derived from an alkenyl aromatic monomer and at least one block (B) comprising repeating alkylene units derived from a conjugated diene monomer. The arrangement of blocks (A) and (B) may be a linear structure (including so-called tapered block copolymers) or a radial teleblock structure having branched chains. A-B-A triblock copolymers have two blocks A comprising repeating aryl allylene units. A-B diblock copolymers have one block A comprising repeating aryl allylene units. The pendant aryl moiety of the aryl alkylene units may be monocyclic or polycyclic and may have a substituent at any available position on the cyclic portion. Suitable substituents include C₁-C₄ alkyl groups. An exemplary aryl alkylene unit is a phenyl-substituted dimethylene unit (—CH(Ph)CH₂—) derived from styrene. Block A may further comprise C₂-C₁₅ alkylene units as long as the mole fraction of aryl alkylene units exceeds the mole fraction of alkylene units.

Block B comprises repeating C₂-C₁₅ allylene units such as ethylene (dimethylene), propylene, butylene, or combinations of two or more of the foregoing. Block B may further comprise aryl alkylene units as long as the mole fraction of alkylene units exceeds the mole fraction of aryl alkylene units. Each occurrence of block A may have a molecular weight which is the same or different than other occurrences of block A. Similarly each occurrence of block B may have a molecular weight which is the same or different than other occurrences of block B.

In one embodiment, the B block comprises a copolymer of aryl alkylene units and C₂-C₁₅ alkylene units such as ethylene, propylene, butylene, or combinations of two or more of the foregoing. The B block may further comprise some unsaturated carbon-carbon bonds. The B block may be a controlled distribution copolymer. As used herein “controlled distribution” is defined as referring to a molecular structure lacking well-defined blocks of either monomer, with “runs” of any given single monomer attaining a maximum number average of 20 units as shown by either the presence of only a single glass transition temperature (Tg), intermediate between the Tg of either homopolymer, or as shown via proton nuclear magnetic resonance methods. Each A block may have an average molecular weight of about 3,000 to about 60,000 g/mol and each B block may have an average molecular weight of about 30,000 to about 300,000 g/mol. Each B block comprises at least one terminal region adjacent to an A block that is rich in alkylene units and a region not adjacent to the A block that is rich in aryl alkylene units. The total amount of aryl alkylene units is 15 to 75 weight percent, based on the total weight of the block copolymer. The weight ratio of alkylene units to aryl alkylene units in the B block may be 5:1 to 1:2. Exemplary block copolymers are further disclosed in U.S. Patent Application No. US 2003/181584 A1 of Handlin et al. International Patent Application No. WO 2003/66696 A1 of Handlin et al. Suitable controlled distribution block copolymers are also commercially available from Kraton Polymers as KRATON® A-RP6936 and KRATON® A-RP6935.

The repeating aryl alkylene units result from the polymerization of aryl alkylene monomers such as styrene, chlorostyrenes such as p-chlorostyrene, methylstyrenes such as alpha-methylstyrene and p-methylstyrene, and combinations thereof. The repeating alkylene units result from the hydrogenation of repeating unsaturated units derived from a conjugated diene such as 1,3-butadiene, 2-methyl-1,3-butadiene (isoprene), 2-chloro-1,3-butadiene (chloroprene), 2,3-dimethyl-1,3-butadiene, 1,3-pentadiene, 1,3-hexadiene, and combinations thereof. The conjugated diene may polymerize via 1,4 addition and/or 1,2 addition. Thus, when the conjugated diene polymerizes via 1,4 addition, the B block may contain in-chain aliphatic carbon-carbon double bonds, and when the conjugated diene polymerizes via 1,2 addition, the B block may contain pendant aliphatic carbon-carbon double bonds.

Exemplary block copolymers include polystyrene-poly(ethylene/propylene), polystyrene-poly(ethylene/propylene)-polystyrene, polystyrene-poly(ethylene/butylene), and polystyrene-poly(ethylene/butylene)-polystyrene.

The acid-functionalized block copolymer may be prepared by graft-reacting an acid moiety or its derivative onto the hydrogenated block copolymer via a free radically initiated reaction. Suitable monomers that may be grafted include unsaturated mono- and polycarboxylic acids and anhydrides containing from about 3 to about 20 carbon atoms. Examples of such monomers are maleic acid, maleic anhydride, methyl maleic acid, methyl maleic anhydride, dimethyl maleic acid, dimethyl maleic anhydride, monochloro maleic acid, monochloro maleic anhydride, dichloro maleic acid, dichloro maleic anhydride, 5-norbornene-2,3-dicarboxylic acids, 5-norbornene-2,3-dicarboxylic acid anhydrides, tetrahydrophthalic acids, tetrahydrophthalic anhydrides, fumaric acid, itaconic acid, itaconic anhydride, citraconic acid, citraconic anhydride, trimellitic acid, trimellitic acid anhydride, trimellitic anhydride acid chloride, and mixtures thereof. In one embodiment, the grafting monomer is maleic anhydride. The grafted polymer will usually contain about 0.1 to about 10 weight percent of the grafted monomer, specifically about 0.2 to about 5 weight percent of the grafted monomer, based on total weight of the grafted polymer.

The grafting reaction can be carried out in solution or by melt-mixing the base block copolymer and the acid/anhydride monomer in the presence of a free radical initiator. Solution processes are described, for example, in U.S. Pat. Nos. 4,033,888 and 4,077,893 to Kiovsky, and 4,670,173 to Hayashi et al. Melt-mixing processes are described, for example, in U.S. Pat. Nos. 4,427,828 to Hergenrother et al., 4,578,429 to Gergen et al., and 4,628,072 and 4,657,971 to Shiraki et al. Suitable acid-functionalized block polymers are also commercially available as, for example, KRATON® FG1901 and KRATON® FG1924 from Kraton Polymers.

In some embodiments, the acid-functionalized block copolymer is a maleic anhydride or fumaric acid-functionalized linear block copolymer or radial teleblock copolymer of styrene and a conjugated diene selected from the group consisting of butadiene, isoprene, and combinations thereof, wherein the an acid-functionalized block copolymer has a styrene content of about 10 to about 50 weight percent.

In some embodiments, the acid-functionalized block copolymer is a maleic anhydride or fumaric acid-functionalized polystyrene-poly(ethylene-butylene)-polystyrene triblock copolymer having a styrene content of about 10 to about 50 parts by weight or a maleic anhydride-functionalized polystyrene-poly(ethylene-butylene) diblock copolymer having a styrene content of about 10 to about 50 parts by weight.

In some embodiment, the crosslinked styrenic block copolymer used in the invention may, optionally, be partially crosslinked, wherein about 90 percent by weight, specifically about 70 percent by weight, more specifically about 50 percent by weight, even more specifically about 30 percent by weight, most specifically about 10 of the initial styrenic block copolymer remains based on the 100 parts by weight total of the initial styrenic block copolymer.

One embodiment is a composition comprising a crosslinked styrenic block copolymer, a poly(arylene ether), and a polyamide, wherein the crosslinked styrenic block copolymer is at least partially crosslinked styrenic block copolymer.

The partially crosslinked styrenic block copolymer exhibits an extent of crosslinking characterized by an average T₁/T₂ value. A ¹H NMR method was used to determine the ratio of the longitudinal or spin-lattice relaxation time, T₁, to the transverse or spin-spin relaxation time, T₂. The average ratio of the spin-lattice relaxation time, T₁, to the transverse or spin-spin relaxation time, T₂, each determined by proton nuclear magnetic resonance (¹H NMR) for the poly(conjugated diene) resonances, may be used as an indicator of the degree of block copolymer crosslinking. When the analysis is conducted on a concentrate of the block copolymer, an average T₁/T₂ value greater than or equal to 530 indicates the presence of crosslinking. Conversely, an average T₁/T₂ value less than 530 indicates an uncrosslinked block copolymer (that is, a block copolymer with negligible crosslinking). For a concentrate, the T₁/T₂ value may be up to about 1,500, specifically up to about 1,000. Average T₁/T₂ values ranging from 557 to at least 728 have been observed for specific block copolymer concentrates. When the analysis is conducted on a composition comprising poly(arylene ether) and block copolymer, an average T₁/T₂ value greater than or equal to 430 indicates the presence of crosslinking. Conversely, an average T₁/T₂ value less than 430 indicates an uncrosslinked block copolymer. For a blend comprising poly(arylene ether) and crosslinked block copolymer, the T₁/T₂ value may be up to about 1,500, specifically up to about 1,000. Average T₁/T₂ values ranging from 463 to at least 767 have been observed for specific blends comprising poly(arylene ether) and crosslinked block copolymer. Measures for determining T₁/T₂ values are described, for example, in U.S. patent application Ser. No. 11/536,755 filed on Sep. 29, 2006.

Another way of measuring the extent of crosslinking for a partially crosslinked styrenic block copolymer is using “liquid extraction” and weight the sample before and after liquid extraction to get the over all gel content.

The composition comprises the crosslinked styrenic block copolymer in an amount of 5 to 60 parts by weight. Within this range, the crosslinked styrenic block copolymer may be present in an amount greater than or equal to 8 parts by weight, or, more specifically, in an amount greater than or equal to 10 parts by weight, or, even more specifically, in an amount greater than or equal to 12 parts by weight. Also within this range the crosslinked styrenic block copolymer may be present in an amount less than or equal to 55 parts by weight, or, more specifically, less than or equal to 50 parts by weight, or, even more specifically, less than or equal to 40 parts by weight. All parts by weight are based on 100 parts by weight total of the poly(arylene ether) and the non-polyolefin crystalline or semi-crystalline resin.

As used herein, a “poly(arylene ether)” comprises a plurality of structural units of the formula:

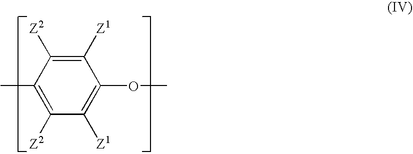

wherein for each structural unit, each Z¹ and Z² is independently hydrogen, halogen, primary or secondary lower alkyl (e.g., an alkyl containing 1 to 7 carbon atoms), phenyl, haloalkyl, aminoalkyl, alkenylalkyl, alkynylalkyl, hydrocarbonoxy, aryl and halohydrocarbonoxy wherein at least two carbon atoms separate the halogen and oxygen atoms. In some embodiments, each Z¹ is independently alkyl or phenyl, for example, C₁₋₄ allyl, and each Z² is independently hydrogen or methyl. The poly(arylene ether) may comprise molecules having aminoalkyl-containing end group(s), typically located in an ortho position to the hydroxy group. Also frequently present are tetramethyldiphenoquinone (TMDQ) endgroups, typically obtained from reaction mixtures in which tetramethyldiphenoquinone by-product is present.

The poly(arylene ether) may be in the form of a homopolymer; a copolymer; a graft copolymer; an ionomer; a block copolymer, for example comprising arylene ether units and blocks derived from alkenyl aromatic compounds; as well as combinations comprising at least one of the foregoing. Poly(arylene ether) includes polyphenylene ether containing 2,6-dimethyl-1,4-phenylene ether units optionally in combination with 2,3,6-trimethyl-1,4-phenylene ether units.

The poly(arylene ether) may be prepared by the oxidative coupling of monohydroxyaromatic compound(s) such as 2,6-xylenol and/or 2,3,6-trimethylphenol. Catalyst systems are generally employed for such coupling; they can contain heavy metal compound(s) such as a copper, manganese or cobalt compound, usually in combination with various other materials such as a secondary amine, tertiary amine, halide or combination of two or more of the foregoing.

The poly(arylene ether) can have a number average molecular weight of 3,000 to 40,000 g per mole (g/mol) and/or a weight average molecular weight of about 5,000 to about 80,000 g/mol, as determined by gel permeation chromatography using monodisperse polystyrene standards, a styrene divinyl benzene gel at 40° C. and samples having a concentration of 1 milligram per milliliter of chloroform. The poly(arylene ether) can have an intrinsic viscosity of 0.10 to 0.60 deciliters per gram (dl/g), or, more specifically, 0.29 to 0.48 dl/g, as measured in chloroform at 25° C. It is possible to utilize a combination of high intrinsic viscosity poly(arylene ether) and a low intrinsic viscosity poly(arylene ether). Determining an exact ratio, when two intrinsic viscosities are used, will depend somewhat on the exact intrinsic viscosities of the poly(arylene ether) used and the ultimate physical properties that are desired.

The composition comprises poly(arylene ether) in an amount of 5 to 65 parts by weight. Within this range, the poly(arylene ether) may be present in an amount greater than or equal to 15 parts by weight, or, more specifically, in an amount greater than or equal to 30 parts by weight, or, even more specifically, in an amount greater than or equal to 40 parts by weight. Also within this range the poly(arylene ether) may be present in an amount less than or equal to 60 parts by weight, or, more specifically, less than or equal to 55 parts by weight, or, even more specifically, less than or equal to 50 parts by weight. All parts by weight are based on 100 parts by weight total of the poly(arylene ether) and the non-polyolefin crystalline or semi-crystalline resin.

In a process of preparation of the composition, the poly(arylene ether) can be added in two stages. For example, one embodiment is to make a masterbatch by melt-kneading an acid functioned styrenic block copolymer, an amine crosslinking agent and a part of poly(arylene ether) in an amount of 15 to 70 percent by weight, more preferably 20 to 60 percent by weight, most preferably 25 to 55 percent by weight, based on the total weight of poly(arylene ether) in the composition; and to blend the masterbatch with the remaining fresh poly(arylene ether), a non-polyolefin crystalline or semi-crystalline resin; and additional components, if present.

The composition may comprise a compatibilizing agent to improve the physical properties of the poly(arylene ether)/non-polyolefin crystalline resin blend.

One embodiment is a thermoplastic composition comprising a crosslinked styrenic block copolymer; a poly(arylene ether); and a non-polyolefin crystalline or semi-crystalline resin; and a compatibilizing agent.

One embodiment is a thermoplastic composition comprising a crosslinked styrenic block copolymer; a poly(arylene ether); a polyamide; and a compatibilizing agent.

One embodiment is a thermoplastic composition comprising a crosslinked styrenic block copolymer; a poly(arylene ether); a polyester, and a compatibilizing agent.

One embodiment is a thermoplastic composition comprising a crosslinked styrenic block copolymer; a compatibilized poly(arylene ether)/non-polyolefin crystalline or semi-crystalline resin selected from the group consisting of a polyamide, a polyester, and a combination thereof.

One embodiment is a thermoplastic composition comprising a crosslinked styrenic block copolymer, and a compatibilized poly(arylene ether)/polyamide blend.

One embodiment is a thermoplastic composition comprising a crosslinked styrenic block copolymer, and a compatibilized poly(arylene ether)/polyester blend.

When used herein, the expression “compatibilizing agent” refers to those polyfunctional compounds which interact with the polyphenylene ether, the non-polyolefin crystalline or semi-crystalline resin, preferably polyamide, or, preferably, both. This interaction may be chemical (e.g. grafting) or physical (e.g. affecting the surface characteristics of the dispersed phases). In either case the resulting poly(arylene ether)/non-polyolefin crystalline resin composition appears to exhibit improved compatibility, particularly as evidenced by enhanced impact strength, mold knit line strength and/or elongation. As used herein, the expression “compatibilized poly(arylene ether)/non-polyolefin crystalline resin” refers to those compositions which have been physically or chemically compatibilized with an agent as discussed above, as well as those compositions which are physically compatible without such agents, as taught, for example, in U.S. Pat. No. 3,379,792.

Suitable compatibilizing agents include, for example, liquid diene polymers, epoxy compounds, oxidized polyolefin wax, quinones, organosilane compounds, polyfunctional compounds, and functionalized polyphenylene ethers obtained by reacting one or more of the previously mentioned compatibilizing agents with polyphenylene ether. Compatibilizing agents are further described in U.S. Pat. Nos. 5,132,365 and 6,593,411 as well as U.S. Patent Application No. 2003/0166762.

The above and other compatibilizing agents are more fully described in U.S. Pat. Nos. 4,315,086; 4,600,741; 4,642,358; 4,826,933; 4,866,114; 4,927,894; 4,980,424; 5,041,504; and 5,115,042.

In one embodiment, the compatibilizing agent comprises a polyfunctional compound. Polyfunctional compounds which may be employed as a compatibilizing agent are of three types. The first type of polyfunctional compounds are those having in the molecule both (a) a carbon-carbon double bond or a carbon-carbon triple bond and (b) at least one carboxylic acid, anhydride, amide, ester, imide, amino, epoxy, orthoester, or hydroxy group. Examples of such polyfunctional compounds include maleic acid; maleic anhydride; fumaric acid; glycidyl acrylate, itaconic acid; aconitic acid; maleimide; maleic hydrazide; reaction products resulting from a diamine and maleic anhydride, maleic acid, fumaric acid, etc.; dichloro maleic anhydride; maleic acid amide; unsaturated carboxylic acids (e.g., acrylic acid, butenoic acid, methacrylic acid, t-ethylacrylic acid, pentenoic acid); decenoic acids, undecenoic acids, dodecenoic acids, linoleic acid, etc.); esters, acid amides or anhydrides of the foregoing unsaturated carboxylic acids; unsaturated alcohols (e.g. alkyl alcohol, crotyl alcohol, methyl vinyl carbinol, 4-pentene-1-ol, 1,4-hexadiene-3-ol, 3-butene-1,4-diol, 2,5-dimethyl-3-hexene-2,5-diol and alcohols of the formula CₙH₂ₙ₋₅OH, CₙH₂ₙ₋₇OH and CₙH₂ₙ₋₉OH, wherein n is a positive integer less than or equal to 30); unsaturated amines resulting from replacing from replacing the —OH group(s) of the above unsaturated alcohols with NH₂ groups; functionalized diene polymers and copolymers; and combinations comprising one or more of the foregoing. In one embodiment, the compatibilizing agent comprises maleic anhydride and/or fumaric acid.

The second type of polyfunctional compatibilizing agents are characterized as having both (a) a group represented by the formula (OR) wherein R is hydrogen or an alkyl, aryl, acyl or carbonyl dioxy group and (b) at least two groups each of which may be the same or different selected from carboxylic acid, acid halide, anhydride, acid halide anhydride, ester, orthoester, amide, imido, amino, and various salts thereof. Typical of this group of compatibilizers are the aliphatic polycarboxylic acids, acid esters and acid amides represented by the formula:

(R^{I}O)ₘR(COOR^{II})ₙ(CONR^{III}R^{IV})ₛ (V)

wherein R is a linear or branched chain, saturated aliphatic hydrocarbon having 2 to 20, or, more specifically, 2 to 10, carbon atoms; R^{I} is hydrogen or an allyl, aryl, acyl, or carbonyl dioxy group having 1 to 10, or, more specifically, 1 to 6, or, even more specifically, 1 to 4 carbon atoms; each R^{II} is independently hydrogen or an alkyl or aryl group having 1 to 20, or, more specifically, 1 to 10 carbon atoms; each R^{III} and R^{IV} are independently hydrogen or an alkyl or aryl group having 1 to 10, or, more specifically, 1 to 6, or, even more specifically, 1 to 4, carbon atoms; m is equal to 1 and (n+s) is greater than or equal to 2, or, more specifically, equal to 2 or 3, and n and s are each greater than or equal to zero and wherein (OR^{I}) is alpha or beta to a carbonyl group and at least two carbonyl groups are separated by 2 to 6 carbon atoms. Obviously, R^{I}, R^{II}, R^{III}, and R^{IV} cannot be aryl when the respective substituent has less than 6 carbon atoms.

Suitable polycarboxylic acids include, for example, citric acid, malic acid, agaricic acid; including the various commercial forms thereof, such as for example, the anhydrous and hydrated acids; and combinations comprising one or more of the foregoing. In one embodiment, the compatibilizing agent comprises citric acid. Illustrative of esters useful herein include, for example, acetyl citrate, mono- and/or distearyl citrates, and the like. Suitable amides useful herein include, for example, N,N′-diethyl citric acid amide; N-phenyl citric acid amide; N-dodecyl citric acid amide; N,N′-didodecyl citric acid amide; and N-dodecyl malic acid. Derivates include the salts thereof, including the salts with amines and the alkali and alkaline metal salts. Exemplary of suitable salts include calcium malate, calcium citrate, potassium malate, and potassium citrate.

The third type of polyfunctional compatibilizing agents are characterized as having in the molecule both (a) an acid halide group and (b) at least one carboxylic acid, anhydride, ester, epoxy, orthoester, or amide group. Examples of compatibilizers within this group include trimellitic anhydride acid chloride, chloroformyl succinic anhydride, chloro formyl succinic acid, chloroformyl glutaric anhydride, chloroformyl glutaric acid, chloroacetyl succinic anhydride, chloroacetylsuccinic acid, trimellitic acid chloride, and chloroacetyl glutaric acid. In one embodiment, the compatibilizing agent comprises trimellitic anhydride acid chloride.

The foregoing compatibilizing agents may be used alone or in various combinations of one another with another. Furthermore, they may be added directly to the melt blend or pre-reacted with either or both the polyphenylene ether and polyamide, as well as with other resinous materials employed in the preparation of the compositions of the present invention.

Where the compatibilizing agent is employed in the preparation of the compositions of the present invention, the initial amount used will be dependent upon the specific compatibilizing agent chosen and the specific polymeric system to which it is added.

When present, the compatibilizing agent may be present in an amount of about 0.01 weight percent to about 25 weight percent. Within this range, it may be preferred to use a compatibilizing agent amount of at least about 0.4 weight percent. Also within this range, it may be preferred to use a compatibilizing agent amounts up to about 10 weight percent, more preferably up to about 3 weight percent, based on the total weight of the composition.

The polymeric composition may further contain one or more agents to improve the impact strength, i.e., an impact modifier. Useful impact modifiers include olefin-containing copolymers such as olefin acrylates and olefin diene terpolymers. An example of an olefin acrylate copolymer impact modifier is ethylene ethylacrylate copolymer available from Union Carbide as DPD-6169. Other higher olefin monomers can be employed as copolymers with alkyl acrylates, for example, propylene and n-butyl acrylate. Olefin diene terpolymers known in the art and generally fall into the EPDM (ethylene propylene diene monomer) family of terpolymers. They are commercially available such as, for example, EPSYN 704 from Copolymer Rubber Company.

Other suitable thermoplastic impact modifiers are block copolymers, for example, A-B diblock copolymers and A-B-A triblock copolymers having of one or two alkenyl aromatic blocks A, which are typically styrene blocks, and a rubber block, B, which is typically an isoprene or butadiene block. The butadiene block may be partially hydrogenated. Mixtures of these diblock and triblock copolymers are especially useful.

Suitable A-B and A-B-A copolymers include but are not limited to polystyrene-polybutadiene, polystyrene-poly(ethylene-propylene), polystyrene-polyisoprene, poly(α-methylstyrene)-polybutadiene, polystyrene-polybutadiene-polystyrene (SBS), polystyrene-poly(ethylene-propylene)-polystyrene, polystyrene-polyisoprene-polystyrene and poly(alpha-methylstyrene)-polybutadiene-poly(alpha-methylstyrene), as well as the selectively hydrogenated versions thereof, and the like. Mixtures of the aforementioned block copolymers are also useful. Styrene-containing polymers can also be used as impact modifiers.

The composition may, optionally, further comprise a filler. The filler may be, for example, a particulate filler or a reinforcing filler. Suitable fillers include, for example, alumina, silica (including fused silica and crystalline silica), boron nitride (including spherical boron nitride), aluminum nitride, silicon nitride, magnesia, magnesium silicate, glass fibers, glass mat, carbon black, carbon nanofibers (including single-wall and multi-wall carbon nanotubes), nanofillers (including those described in U.S. Patent Application Serial No. US 2004/0122153 of Guo et al.), and the like, and combinations thereof. In some embodiments, the filler is one that does not detract from the desirable optical properties of the composition. Thus, in some embodiments, the filler comprises less than 5 parts by weight of particles having any dimension greater than 200 nanometers. The filler may be substantially free of particles having any dimension greater than 200 nanometers. Suitable fillers may include, for example, nanotalcs, fumed silicas, and nanoclays. When present, the inorganic filler may be used in an amount of about 1 to about 70 parts by weight, based on the total weight of the composition. In some embodiments, the composition comprises less than 50 parts by weight filler, or less than 30 parts by weight filler, or less than 10 parts by weight filler. In some embodiments, the composition is free of filler (that is, no filler is intentionally added).

The composition may, optionally, further comprise various additives known in the thermoplastics art. For example, the composition may, optionally, further comprise an additive chosen from stabilizers; mold release agents, processing aids, flame retardants, drip retardants, nucleating agents, UV blockers, dyes, pigments, antioxidants, anti-static agents, blowing agents, mineral oil, metal deactivators, antiblocking agents, and the like, and combinations thereof. Additives may be added in amounts that do not unacceptably detract from the desired optical and physical properties of the composition. Such amounts may be determined by a skilled artisan without undue experimentation.

Suitable stabilizers used in a thermoplastic composition are known in the art. Exemplary stabilizers comprise hindered phenol anti-oxidant, Irganox 1076 (CAS Reg. No. 2082-79-3, Tradename: Evemox 76, Everspring), pentaerythritol tetrastearate (CAS Reg. No. 115-83-3, Tradename: GYLCOLUB P (PE-18)), cupric acetate monohydrate (CAS Reg. No. 6046-93-1, Tradename: Cupric Acetate, Barker Industries, Inc.), cupric chloride dihydrate (CAS Reg. No. 10125-13-0, Tradename: Cupric Chloride Dihydrate, Barker Industries, Inc.), citric acid (anhydrous)(CAS Reg. No. 77-92-9, Tradename: Citric Acid, anhydrous, Cargill Inc.), potassium iodide (CAS Reg. No. 7681-11-0, Tradename: Potassium Iodide, Deepwater), cuprous iodide (CAS Reg. No. 7681-65-4, Tradename: cuprous iodide, Ajay North), or the like.

In one embodiment, the composition is substantially free of any thermoplastic or thermoset resin other than those described above. For example, the composition may be substantially free of an epoxy resin. As other examples, the composition may be substantially free of polyolefin, or substantially free of syndiotactic polystyrene.

The composition exhibits various improved properties relative to compositions in which the styrenic block copolymer is not crosslinked.

In one embodiment, a composition comprises 5 to 60 parts by weight of a crosslinked styrenic block copolymer; 5 to 65 parts by weight of a poly(arylene ether); and 35 to 95 parts by weight of a non-polyolefin crystalline or semi-crystalline resin comprising a polyamide or a polyester; wherein all parts by weight are based on 100 parts by weight total of the poly(arylene ether) and the non-polyolefin crystalline or semi-crystalline resin.

In one embodiment, a composition comprises 5 to 60 parts by weight of a crosslinked styrenic block copolymer; 5 to 65 parts by weight of a poly(arylene ether); and 35 to 95 parts by weight of a polyamide; wherein all parts by weight are based on 100 parts by weight total of the poly(arylene ether) and the polyamide.

In one embodiment, a composition comprises 5 to 60 parts by weight of a crosslinked styrenic block copolymer; 40 to 95 parts by weight of a compatibilized poly(arylene ether)/non-polyolefin crystalline or semi-crystalline resin.

In one embodiment, a composition comprises 5 to 60 parts by weight of a crosslinked styrenic block copolymer; 40 to 95 parts by weight of a compatibilized poly(arylene ether)/non-polyolefin crystalline or semi-crystalline resin selected from the group consisting of a polyamide, a polyester, or a combination thereof.

In one embodiment, a composition comprises 5 to 60 parts by weight of a crosslinked styrenic block copolymer comprising the blend obtained on melt-kneading a maleic anhydride or fumaric acid-functionalized linear block copolymer or radial teleblock copolymer of (A) at least one block derived from an alkenyl aromatic monomer and (B) at least one block derived from a conjugated diene selected from the group consisting of butadiene, isoprene, and mixtures thereof; an amine or polyamine; 5 to 65 parts by weight of a poly(arylene ether) comprising 2,6-dimethyl-1,4-phenylene ether units, 2,3,6-trimethyl-1,4-phenylene ether units, or a combination thereof; and 35 to 95 parts by weight of a polyamide comprising nylon-6, nylon-6,6, or a combination thereof; wherein all parts by weight are based on 100 parts by weight total of the poly(arylene ether) and the polyamide; optionally, a filler; and optionally, an additive selected from the group consisting of stabilizers, mold release agents, processing aids, flame retardants, drip retardants, nucleating agents, UV blockers, dyes, pigments, antioxidants, anti-static agents, blowing agents, mineral oil, metal deactivators, antiblocking agents, and combinations thereof.

One embodiment is a composition, comprising: a poly(arylene ether) comprising 2,6-dimethyl-1,4-phenylene ether units and having an intrinsic viscosity of about 0.3 to about 0.6 deciliter per gram, measured at 25° C. in chloroform; and a crosslinked styrenic block copolymer of (A) at least one block derived from an alkenyl aromatic monomer and (B) at least one block derived from a conjugated diene; wherein the crosslinked block copolymer comprises about 60 to about 85 parts by weight of repeating units derived from the alkenyl aromatic monomer; wherein the alkenyl aromatic monomer is styrene; wherein the conjugated diene is 1,3-butadiene, 2-methyl-1,3-butadiene, or a combination thereof; and wherein the composition exhibits an extent of partially crosslinking characterized by an average T₁/T₂ value of 463 to 767.

One embodiment is a composition, consisting of: a poly(arylene ether) comprising 2,6-dimethyl-1,4-phenylene ether units and having an intrinsic viscosity of about 0.3 to about 0.6 deciliter per gram, measured at 25° C. in chloroform; and a crosslinked block copolymer of (A) at least one block derived from an alkenyl aromatic monomer and (B) at least one block derived from a conjugated diene; wherein the crosslinked block copolymer comprises about 60 to about 85 parts by weight of repeating units derived from the alkenyl aromatic monomer; wherein the alkenyl aromatic monomer is styrene; wherein the conjugated diene is 1,3-butadiene, 2-methyl-1,3-butadiene, or a combination thereof; wherein the crosslinked block copolymer comprises the reaction product of an uncrosslinked block copolymer and a peroxide compound; optionally, a crosslinked block copolymer of (A) at least one block derived from an alkenyl aromatic monomer and (B) at least one block derived from a conjugated diene; wherein the crosslinked block copolymer comprises about 10 to less than 50 parts by weight of repeating units derived from the alkenyl aromatic monomer; optionally, an uncrosslinked block copolymer of (A) at least one block derived from an alkenyl aromatic monomer and (B) at least one block derived from a conjugated diene; optionally, a filler; and optionally, an additive selected from the group consisting of stabilizers, mold release agents, processing aids, flame retardants, drip retardants, nucleating agents, UV blockers, dyes, pigments, antioxidants, anti-static agents, blowing agents, mineral oil, metal deactivators, antiblocking agents, and combinations thereof, and wherein the composition exhibits an extent of crosslinking characterized by an average T₁/T₂ value of 463 to 767.

The crosslinked styrenic block copolymer may be used in an amount of about 1 to about 80 parts by weight of the crosslinked block copolymer per 100 parts by weight total of the poly(arylene ether) and the crosslinked styrenic block copolymer. Within this range, the crosslinked styrenic block copolymer amount may be at least about 5 parts by weight, or at least about 10 parts by weight. Also within this range, the crosslinked styrenic block copolymer amount may be up to about 70 parts by weight, or up to about 50 parts by weight, or up to about 30 parts by weight, or up to about 20 parts by weight.

The poly(arylene ether), the acid-functionalized block copolymer, and the amine crosslinking agent may be melt-kneading in proportions that provide the desired property balance. For example, in one embodiment, the composition before melt-kneading comprises about 20 to about 99 parts by weight of the poly(arylene ether), about 1 to about 80 parts by weight of the acid-functionalized block copolymer, and about 0.01 to about 5 parts by weight of the amine crosslinking agent, wherein all parts by weight are based on 100 parts by weight total of the poly(arylene ether) and the acid-functionalized block copolymer. Within the above range of about 20 to about 99 parts by weight, the poly(arylene ether) amount may be at least about 50 parts by weight, or at least about 80 parts by weight, or up to about 95 parts by weight, or up to about 90 parts by weight. Within the above range of about 1 to about 80 parts by weight, the acid-functionalized block copolymer amount may be at least about 5 parts by weight, or at least about 10 parts by weight, or up to about 50 parts by weight, or up to about 20 parts by weight. Within the above range of about 0.01 to about 5 parts by weight, the amine crosslinking agent amount may be at least about 0.1 part by weight, or at least about 0.2 part by weight, or up to about 2 parts by weight, or up to about 1 part by weight.

The composition may be prepared by any method capable of forming an intimate blend of the poly(arylene ether); the non-polyolefin crystalline or semi-crystalline resin comprising a polyamide, a polyester, or a combination thereof; the crosslinked styrenic block copolymer. As noted above, the crosslinked styrenic block copolymer may be crosslinked before or after blending with the poly(arylene ether). However, there appear to be some physical property advantages to crosslinking the styrenic block copolymer in melt-kneading a styrenic block copolymer, a crosslinking agent and a part of poly(arylene ether) to form a masterbatch; then blending the masterbatch with the remaining fresh poly(arylene ether); the non-polyolefin crystalline or semi-crystalline resin; and additional components, for example stabilizers, impact modifiers, anti-oxidants or the like, to obtain the final composition.

Another embodiment is an article comprising any of the above-described compositions. In one embodiment, an article comprises a thermoplastic composition comprising a continuous phase comprising the non-polyolefin crystalline or semi-crystalline resin; and a dispersed phase comprising a crosslinked styrenic block copolymer. In another embodiment, an article comprises a thermoplastic composition comprising a poly(arylene ether); a crosslinked styrenic block copolymer; and a non-polyolefin crystalline or semi-crystalline resin. For example, an article may comprise a film, sheet, molded object, or composite, wherein the film, sheet, molded object or composite comprises at least one layer comprising the composition. Articles may be prepared from the composition using fabrication methods known in the art, including, for example, single layer and multilayer foam extrusion, single layer and multilayer sheet extrusion, injection molding, blow molding, extrusion, film extrusion, profile extrusion, pultrusion, compression molding, thermoforming, pressure forming, hydroforming, vacuum forming, foam molding, and the like. Combinations of the foregoing article fabrication methods may be used. Articles for which the composition may be used include, for example, heat-resistant product packaging, appliance and business machine housings, cell phone holders, printer ink cartridges, automotive parts, and electrical apparatus housings.

It has been found that the present composition may be conveniently prepared by a one-step process comprising melt-kneading poly(arylene ether), a non-polyolefin crystalline or semicrystalline resin, a crosslinked styrenic block copolymer and additional components, if necessary.

In a two-step process for the preparation of the present composition, a method comprising firstly preparing a masterbatch by melt-kneading an acid functionalized styrenic block copolymer, an amine crosslinking agent, and a part of poly(arylene ether); then blending the masterbatch with the remaining poly(arylene ether), the non-polyolefin crystalline or semicrystalline resin, and additional components, if any.

In one embodiment, the crosslinked styrenic block copolymer is obtained by melt-kneading an acid-functionalized block copolymer comprising (A) at least one block derived from an alkenyl aromatic monomer and (B) at least one block derived from a conjugated diene, an amine crosslinking agent, and a part of poly(arylene ether) to obtain a masterbatch; then blending the masterbatch with the remaining poly(arylene ether), the non-polyolefin crystalline or semicrystalline resin, and additional components, if any.

One embodiment is a method comprising melt-kneading the acid-functioned styrenic block copolymer with an amine crosslinking agent in the presence of a part of poly(arylene ether) as a matrix component to obtain a masterbatch; and blending the remaining poly(arylene ether); the non-polyolefin crystalline or semi-crystalline resin comprising a polyamide, a polyester or a combination thereof; and additional components, if any, to make a final composition of present invention.

One embodiment is a method comprising the step of obtaining a masterbatch by melt-kneading an acid-functioned styrenic block copolymer and an crosslinking agent in the presence of the non-polyolefin crystalline or semi-crystalline resin as a minor component; and blending the masterbatch, the poly(arylene ether), remaining non-polyolefin crystalline or semi-crystalline resin, and additional components comprising a compatibilizing agent, additives, or the like.

In one embodiment, a method comprises adding a poly(arylene ether) in melt-kneading an acid-functioned styrenic block copolymer and amino-containing crosslinking agent; and blending the polyamide and remaining poly(arylene ether).

In one embodiment, the acid-functioned block copolymer is obtained by functionalizing a styrenic block copolymer comprising (A) at least one block derived from an alkenyl aromatic monomer and (B) at least one block derived from a conjugated diene with maleic anhydride or fumaric acid, optionally in the presence of a peroxide.

One method of forming an intimate blend of the poly(arylene ether) and a crosslinked styrenic block copolymer comprises melt-kneading the poly(arylene ether) and an acid-functionalized styrenic block copolymer and an amine crosslinking agent. In one embodiment, the crosslinking of the acid-functionalized block copolymer and blending of all components were conducted simultaneously in a single melt-kneading process wherein an acid-functionalized styrenic block copolymer, and a poly(arylene ether) are added up-stream to an extruder (for example, at the feed throat), an amine crosslinking agent is added at the middle section of the extruder (down stream), and a non-polyolefin crystalline resin and other additives, if present, are added further down stream.

Apparatus suitable for preparing an intimate blend via melt kneading includes, for example, a two-roll mill, a Banbury mixer, and a single-screw or twin-screw extruder. In one embodiment, melt kneading comprises using a twin-screw extruder.

All percentages, parts and ratios are based upon the total weight of the composition of the present invention unless otherwise specified.

The invention is further illustrated by the following non-limiting examples.

### EXAMPLES AND COMPARATIVE EXAMPLES

These examples demonstrate the effects of incorporating a crosslinked styrenic block copolymer into a combination of a poly(arylene ether) and a non-polyolefin crystalline or semi-crystalline resin, and effects of varying the concentrations of the components, and the processes of the preparation of the composition. The poly(arylene ether) (“PPE”, 461V) was a poly(2,6-dimethyl-1,4-phenylene ether) having an initial intrinsic viscosity of about 0.46 deciliter per gram, obtained from GE Plastics. The acid-functionalized block copolymer (“Acid-fxnd. copolymer”) was a maleic anhydride or fumaric acid-grafted, polystyrene-poly(ethylene-butylene)-polystyrene triblock copolymer having a styrene content of 30% and about 1.4-2.0% bound maleic anhydride or fumaric acid, obtained as KRATON® FG1901X from Kraton Polymers. The amine crosslinking agent was a polyethenimine obtained as LUPASOL® FG from BASF. Component amounts are shown in Tables 2 to 6. The amounts used in the following tables are given in parts by weight.

TABLE 1
Definitions of Components used in Examples

| Common name | CAS# | Tradename |
|---|---|---|
| PPE | 25134-01-4 | 0.46IV PPO |
| SEP diblock | 68648-89-5 | Kraton G 1701, Kraton Polymers |
| copolymer | | |
| SEBS | 66070-58-4 | Kraton G1651, Kraton Polymers |
| SEBS | 66070-58-4 | Kraton G1652, Kraton Polymers |
| Maleated SEBS | 124578-11-6 | Kraton FG1901X, Kraton |
| | | Polymers |
| SBS | | Kraton D1102, Kraton Polymers |
| SEPS | | Kraton G 1702, Kraton Polymers |
| polyamines | 25987-06-8 | Lupasol FG, BASF |
| Polyamide 6 with | 25038-54-4 | Rhodia |
| high amine content | | |
| Polyamide 66, | 32131-17-2 | Vydyne 21ZLV, Solutia Inc. |
| high flow | | |
| Polyamide 66 | 32131-17-2 | Zytel FE3637NC10, Dupont |
| FIBREGLASS | 65997-17-3 | Owens Corning 173X-11C |

The general procedure for preparation of crosslinked styrenic block copolymer materbatch is as follows. Masterbatch compositions are detailed in Table 2, where all component amounts are expressed in parts by weight. The crosslinking of the acid-functionalized block copolymer and blending of all components were conducted simultaneously in a melt-kneading process. A dry blend containing the poly(arylene ether), the amine crosslinking agent, and the acid-functionalized block copolymer were added in the feed throat in a 30-millimeter, 10-zone twin-screw extruder operating at 350 rotations per minute with barrel temperatures from feed throat to die of 260° C. to 290° C. The twin-screw extruder uses a down stream feeder in zone 7 out of 10 zones. A vacuum vent is located in zone 10 with 20-25 inches of mercury vacuum being applied. The feed rate was about 16-18 kilograms per hour (35-40 pounds per hour). The screw design employed had fairly intensive mixing in zones 2 to 4 with relatively mild mixing in zone 9. The extrudate was cooled and pelletized.

Gel content is indicative of the extent of the crosslinking of the crosslinked styrenic block copolymer, and can be measured according to “liquid extraction” by weighing the sample before and after Soxhlet extraction using chloroform under reflux for 48 hrs to get the overall gel content.

Flexural modulus was measured according to ASTM D 790 Method A at 23° C. using samples having a depth of 3.2 millimeters and a width of 12.7 millimeters, a support span length of 5.08 centimeters (2 inches), and a crosshead motion rate of 0.127 centimeter/minute (0.05 inch/minute).

Heat deflection temperature (HDT) was measured according to ASTM D 648-06, Standard Test Method for Deflection Temperature of Plastics Under Flexural Load in the Edgewise Position. Three specimens were conducted on ASTM HDT bars for average.

Vicat softening temperature was measured according to ASTM D1525-06, Standard Test Method for Vicat Softening Temperature of Plastics. In the test, a 3.2 mm bar was used with a load of 50 N at a heating rate of 120B (120° C./h). Three samples were used for the calculation of the average.

Impact strength was measured according to ASTM D 256-05, Standard Test Method for Determining the IZOD Pendulum Impact Resistance of Plastics. ASTM 3.2 mm thickness Izod bars was used in the test. Method A-“notched” used unless specifically stated un-notched. The sample was conducted at a temperature of 23° C. or −30° C. Five samples were tested for averages.

Tensile was measured according to ASTM D 638 uniaxial tensile test with extensometer and unfilled Materials at a test speed of 50 mm/min. The samples used in the test are standard ASTM bars and the results are given in metric units. Five measurements were used for averages. The same method was used for filled materials except that the testing speed was 5 mm/min.

MAI was measured according to ASTM D3763-02 Standard Test Method for High Speed Puncture Properties of Plastics Using Load and Displacement Sensors. 3.2 mm thick disk samples were used for testing. Average was calculated on five samples.

MFR was measured according to ASTM D1238-04c, Standard Test Method for Melt Flow Rates of Thermoplastics by Extrusion Plastometer. Five samples used for average calculation. Conditions for the test include measuring the samples at a temperature of 280° C. with a load of 5 kg for 375 s.

CTE was measured according to ASTM E831 Coefficient of Thermal

Expansion. The start temperature is 30° C. to 150° C. at a speed of 20° C./min. One sample was used for determination in each direction flow and cross-flow.

The compositions were prepared by two-step process. In the first step, a masterbatch was obtained by melt-kneading PPE, SEBS, Maleated SEBS and polyamine in the amounts as shown in Table 2. The masterbatch was then blended with remaining PPE and Polyamide 66 (Nylon 66) in the amounts as shown in Table 3 in the second step to obtain the thermoplastic composition.

In the examples or comparative examples, all contents were given in parts by weight unless otherwise specified.

TABLE 2
Compositions of Masterbatches

| COMPONENT | C. Ex. 1 | Ex. 2 | C. Ex. 3 | Ex. 4 | C. Ex. 5 | Ex. 6 |
|---|---|---|---|---|---|---|
| PPE | 70 | 70 | 55 | 55 | 85 | 85 |
| KG1652 | 30 | | 45 | | 15 | |
| FG1901X | | 30 | | 45 | | 15 |
| Lupasol | | 0.25 | | 0.3 | | 0.125 |
| Gel Content 1 | 0 | 20.6 | 0.06 | 28.1 | 0 | 6.5 |
| Gel Content 2 | 0 | 21.1 | 0.03 | 29.6 | 0 | 7.4 |
| Gel Content 3 | 0 | 20.6 | 0.09 | 27.9 | 0 | 2.4 |
| % insolubles | 0 | 20.8 | 0.1 | 28.5 | 0 | 5.4 |
| % of | 0 | 69 | 0 | 63 | 0 | 36 |
| Crosslinked | | | | | | |
| styrenic block | | | | | | |
| copolymer | | | | | | |

C. Ex. is for comparative example
Ex. is for present example

Masterbatches were prepared according to the compositions shown in the above examples. Gel content is an indicative of the extent of the crosslinking of the crosslinked styrenic block copolymer, as can be measured according to “liquid extraction” by weighing the sample before and after Soxhlet extraction using chloroform under reflux for 48 hrs to get the over all gel content. Three measurements were conducted for one sample and reported as Gel Content 1, 2, and 3 respectively. % insolubles means an average for the three gel contents. % of crosslinked styrenic block copolymer represents an average ratio of gel content (crosslinked styrenic block copolymer) to initial components including FG1901X and Lupasol, which were used for preparation of the crosslinked styrenic block copolymer,

TABLE 3
Compositions

| | Example | | | | | | | | | | |
|---|---|---|---|---|---|---|---|---|---|---|---|
| | 7 | 8 | 9 | 10 | 11 | 12 | 13 | 14 | 15 | 16 | 17 |
| Process and Crosslinking | Blend¹ | MB-X² | MB-U³ | MB-X | MB-X | Blend | MB-U | MB-X | Blend | MB-U | MB-X |
| PPE (parts by weight) | 40 | 5 | 21.69 | 21.69 | 15 | 49 | 41.67 | 41.67 | 35 | 10.58 | 10.58 |
| Stabilizer | 0.3-1.5 | 0.3-1.5 | 0.3-1.5 | 0.3-1.5 | 0.3-1.5 | 0.3-1.5 | 0.3-1.5 | 0.3-1.5 | 0.3-1.5 | 0.3-1.5 | 0.3-1.5 |
| Kraton-G 1652 | 15 | | | | | 6 | | | 20 | | |
| Com. Ex. 1 (Uncrosslinked-) | | | | | | | | | | | |
| Ex. 2 Crosslinked- | | 50 | | | | | | | | | |
| Com. Ex. 3 (Uncrosslinked-) | | | 33 | | | | 13.33 | | | 44 | |
| Ex. 4 (Crosslinked-) | | | | 33 | | | | 13.33 | | | 44 |
| Com. Ex. 5 (Uncrosslinked-) | | | | | | | | | | | |
| Ex. 6 (Crosslinked-) | | | | | 40 | | | | | | |
| Polyamide 66 | 45 | 45 | 45 | 45 | 45 | 45 | 45 | 45 | 45 | 45 | 45 |

¹Blend represents preparation of the composition without crosslinked styrenic block copolymer by one-step process;
²MB-X represents preparation of the composition with crosslinked styrenic block copolymer by two-step process; and
³MB-U represents preparation of the composition without crosslinked styrenic block copolymer by two-step process.

TABLE 4
Test Results

| | | Ex. 7 | Ex. 9 | Ex. 10 | Ex. 12 | Ex. 13 | Ex. 14 | Ex. 15 | Ex. 16 | Ex. 17 |
|---|---|---|---|---|---|---|---|---|---|---|
| Item Description | | | | | | | | | | |
| Process and Crosslinking* | | Blend | MB-U | MB-X | Blend | MB-U | MB-X | Blend | MB-U | MB-X |
| % Crosslinked or uncrosslinked styrenic | | 15 | 15 | 15 | 6 | 6 | 6 | 20 | 20 | 20 |
| block copolymer | | | | | | | | | | |
| Total Weight of Composition (by parts) | | 101.2 | 100.89 | 100.89 | 101.2 | 101.2 | 101.2 | 101.2 | 100.78 | 100.78 |
| Test Description | Unit | | | | | | | | | |
| Flexural Modulus | MPa | 1240 | 1180 | 1610 | 1990 | 1920 | 2080 | 1220 | 1020 | 1450 |
| HDT (0.455 MPa) | ° C. | 156 | 145 | 186 | 189 | 188 | 194 | 125 | 118 | 170 |
| HDT (1.82 MPa) | ° C. | 62.3 | 61.7 | 72.3 | 104 | 100 | 112 | 59.3 | 56.2 | 62.4 |
| Vicat (120B, 50) | ° C. | 135 | 119 | 188 | 201 | 193 | 207 | 113 | 99.7 | 160 |
| Impact Strength (N, 23° C.) | J/m | 103 | 127 | 210 | 81.5 | 74.3 | 144 | 204 | 126.91 | 189 |
| Impact Strength (N, −30° C.) | J/m | 98.7 | 123 | 181 | 77.1 | 60.8 | 137 | 219 | 149 | 160 |
| Modulus of Elasticity | MPa | 1300 | 1394 | 1822 | 2338 | 1916 | 2218 | 1258 | 1220 | 1544 |
| Elongation at Yield | % | 39 | 47 | 17 | 5.8 | 25 | 8.7 | 80 | 57 | 31 |
| Elongation at Break | % | 39 | 47 | 66 | 22 | 26 | 84 | 110 | 71 | 74 |
| MAI Total Energy (23° C.) | J | 29.9 | 21 | 55 | 34.6 | 14.1 | 65.5 | 49 | 24.9 | 51 |
| MAI Total Energy (−30° C.) | J | 3.34 | 3.68 | 37.1 | 6.44 | 3.76 | 34.3 | 7.7 | 3.9 | 35.7 |
| MFR (280° C., 5 Kg) | g/10 min | 31.7 | 27.1 | 10 | 68.2 | 22.4 | 17.4 | 30.2 | 30 | 3.67 |
| CTE (30-150° C., | ppm | 111.2 | 107.9 | 136 | 106.5 | 105.3 | 113.4 | | 108 | 148.6 |
| 20° C./min, flow) | | | | | | | | | | |

*Blend, MB-U and MB-X were given under Table 3

It can be seen from the above table that the thermoplastic compositions with the crosslinked styrenic block copolymer resulted in both high ductility and high heat distortion temperature. In contrast, those thermoplastic compositions in Examples 7, 9, 12, 13, 15, and 16 without the crosslinked styrenic block copolymer result in either an improvement in ductility and impact resistance while at the same time decrease in the heat distortion temperature or Vicat softening temperature; or result in an improvement in heat distortion temperature or Vicat softening temperature while compromise ductility and impact resistance. It is apparent that the present compositions produce unexpected balance of ductility or impact resistance and high heat distortion temperature or Vicat softening temperature. In all cases the MB-X samples are showing improved properties relative to those without the crosslinked styrenic block copolymer.

It can be seen from the Table 4 that the composition comprising the crosslinked styrenic block copolymer shows either an increase in impact performance, and increase in elongation, or an increase in heat deflection temperature, or combinations of these properties.

TABLE 5
Test Results

| | | Ex. 8 | Ex. 10 | Ex. 11 | Ex. 14 |
|---|---|---|---|---|---|
| Item Description | | | | | |
| Process and Crosslinking¹ | | MB-X | MB-X | MB-X | MB-X |
| % Crosslinked Styrenic Block | | 15 | 15 | 6 | 6 |
| Copolymer² | | | | | |
| % Remaining PPE as fresh | | 13 | 54 | 31 | 85 |
| powder³ | | | | | |
| Test Description | Unit | | | | |
| HDT (0.455 MPa) | ° C. | 190 | 186 | 195 | 194 |
| Vicat (120B, 50) | ° C. | 191 | 188 | 207 | 207 |
| Impact Strength | J/m | 66 | 210 | 81.1 | 144 |
| (N, 23° C.) | | | | | |
| Impact Strength | J/m | 62 | 181 | 80.7 | 137 |
| (N, −30° C.) | | | | | |
| Elongation at Yield | % | 17 | 17 | 26 | 8.7 |
| Elongation at Break | % | 22 | 66 | 43 | 84 |
| MAI Total Energy | J | 8.96 | 55 | 15.8 | 65.5 |
| (23° C.) | | | | | |
| MAI Total Energy | J | 3.26 | 37.1 | 3.6 | 34.3 |
| (−30° C.) | | | | | |
| MFR (280° C., 5 Kg) | g/10 min | 19.3 | 10 | 18.6 | 17.4 |

¹Blend, MB-U and MB-X were given under Table 3
²% Crosslinked Styrenic Block Copolymer was calculated in weight percent according to Table 2 and Table 3
³% Remaining PPE as fresh powder was PPE (weight percent) added in the second step relative to the total PPE used in the composition

This table shows that the addition of fresh PPE after the preparation of the masterbatch comprising the crosslinked styrenic block copolymer brings about excellent effects in the improvement in ductility, impact resistance, high heat distortion temperature and Vicat softening temperature.

TABLE 6
Formulations with various ratios of poly(arylene ether)/polyamide and crosslinked styrenic block copolymer

| | Example | | | | | | | | | |
|---|---|---|---|---|---|---|---|---|---|---|
| | 18 | 19 | 20 | 21 | 22 | 23 | 24 | 25 | 26 | 27 |
| PPE | 34.26 | 34.26 | 46.61 | 46.61 | 34.57 | 17.52 | 17.52 | 17.52 | 15.69 | 15.69 |
| IRG 1076 | 0.28 | 0.28 | | | | 0.30 | 0.30 | 0.30 | 0.60 | 0.60 |
| PETS | | | | | | 0.30 | 0.30 | 0.30 | | |
| KG1651 | | | | | | | | | | |
| Stabilizer | 0.5-2 | 0.5-2 | 0.5-2 | 0.5-2 | 0.5-2 | 0.5-2 | 0.5-2 | 0.5-2 | 0.5-2 | 0.5-2 |
| KG1701 | | | | | | | | 7.98 | | |
| C. Ex. 3 | 13.17 | | 12.04 | | | 33.24 | | | 33.15 | |
| (uncrosslinked) | | | | | | | | | | |
| Ex. 4 | | 13.17 | | 12.04 | 24.08 | | 33.24 | 15.51 | | 33.15 |
| (crosslinked) | | | | | | | | | | |
| CC MB in nylon | | | | | | | | | 24.87 | 24.87 |
| High amine PA6 | | | | | | | | | 9.95 | 9.95 |
| High flow PA66 | | | | | | 47.85 | 47.85 | 47.85 | 14.92 | 14.92 |
| PA66 (DUPONT) | 41.49 | 41.49 | 40.41 | 40.41 | 40.41 | | | | | |
| Total | ~100.00 | ~100.00 | ~100.00 | ~100.00 | ~100.00 | ~100.0 | ~100.00 | ~100.00 | ~100.00 | ~100.00 |

TABLE 7
Test Results

| | | Ex. 18 | Ex. 19 | Ex. 20 | Ex. 21 | Ex. 22 | Ex. 23 | Ex. 24 | Ex. 25 | Ex. 26 | Ex. 27 |
|---|---|---|---|---|---|---|---|---|---|---|---|
| Item Description | | | | | | | | | | | |
| Process and Crosslinking | | MB-U | MB-X | MB-U | MB-X | MB-X | MB-U | MB-X | MB-X | MB-U | MB-X |
| % Crosslinked or | | 5.93 | 5.93 | 5.42 | 5.42 | 10.84 | 14.95 | 14.95 | 6.98 | 14.92 | 14.92 |
| Uncrosslinked Styrenic | | | | | | | | | | | |
| Block Copolymer¹ | | | | | | | | | | | |
| Test Description | Unit | | | | | | | | 25 | 26 | 27 |
| Flexural Modulus | MPa | 3240 | 3540 | 2150 | 2440 | 2130 | 1190 | 1580 | 1660 | 1350 | 1750 |
| Flex Stress@5% Strain | MPa | 119 | 132 | 82.9 | 97.2 | 83.8 | 47.1 | 61.2 | 64.9 | 51.9 | 64.8 |
| HDT (0.455 MPa, 3.2 mm) | ° C. | 229 | 230 | 199 | 199 | 198 | 146 | 184 | 177 | 139 | 180 |
| HDT (1.82 MPa, 3.2 mm) | ° C. | 197 | 197 | 123 | 143 | 102 | 70 | 75.5 | 79.1 | 70 | 79.6 |
| Vicat Temperature | ° C. | 211 | 217 | 206 | 210 | 202 | 114 | 177 | 175 | 119 | 163 |
| (50, 120B) | | | | | | | | | | | |
| Izod Impact Strength | J/m | 68.3 | 94.2 | 79.4 | 145 | 257 | 49.4 | 146 | 646 | 83.4 | 86.6 |
| (N, 23° C.) | | | | | | | | | | | |
| Izod Impact Strength | J/m | 72.6 | 92.1 | 74.7 | 130 | 170 | 47.3 | 124 | 289 | 70.2 | 77.8 |
| (N, −30° C.) | | | | | | | | | | | |
| MAI Total Energy (23° C.) | J | 11.1 | 11.7 | 18.8 | 67.5 | 56.1 | 6.4 | 55.4 | 57.1 | 6.46 | 31.9 |
| MAI Total Energy (−30° C.) | J | 8.3 | 11.5 | 7.18 | 59.7 | 61.7 | 2.36 | 32.6 | 70.6 | 5.04 | 15.5 |
| Modulus of Elasticity | MPa | 3272 | 3550 | | 2165 | 1924 | 1246 | 1674 | 1744 | 1398 | 1778 |
| Elongation at Yield | % | 5.7 | 4.4 | | 10 | 7.8 | 19 | 30 | 31 | 36 | 19 |
| Elongation at Break | % | 8.7 | 8.1 | | 37 | 87 | 19 | 51 | 43 | 36 | 19 |

¹% Crosslinked or Uncrosslinked Styrenic Block Copolymer was calculated by weight percent according to Table 2 and Table 3

These examples demonstrate the effects of varying the concentrations of the crosslinked styrenic block copolymer. Moreover, it is shown from the Table 7 that compositions with the crosslinked styrenic block copolymer is better than those without the crosslinked styrenic block copolymer. It is apparent that the results in Table 7 show an increase in impact while maintaining Vicat or HDT, or an increase in HDT/Vicat while maintaining impact strength. In some cases elongation increases simultaneously with increases in impact strength and Vicat or HDT.

According to examples presented above, it is clear that the thermoplastic resin composition comprising a poly(arylene ether), a non-polyolefin crystalline or semi-crystalline resin, and a crosslinked styrenic block copolymer significantly enhanced the ductility and impact resistance while maintaining heat distortion temperature or Vicat softening temperature and therefore exhibits improved balances of thermal resistance and impact strength.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

All cited patents, patent applications, and other references are incorporated herein by reference in their entirety. However, if a term in the present application contradicts or conflicts with a term in the incorporated reference, the term from the present application takes precedence over the conflicting term from the incorporated reference.

All ranges disclosed herein are inclusive of the endpoints, and the endpoints are independently combinable with each other.

The use of the terms “a” and “an” and “the” and similar referents in the context of describing the invention (especially in the context of the following claims) are to be construed to cover both the singular and the plural, unless otherwise indicated herein or clearly contradicted by context. Further, it should further be noted that the terms “first,” “second,” and the like herein do not denote any order, quantity, or importance, but rather are used to distinguish one element from another. The modifier “about” used in connection with a quantity is inclusive of the stated value and has the meaning dictated by the context (for example, it includes the degree of error associated with measurement of the particular quantity).

What is claimed is:

1. A thermoplastic composition comprising
a poly(arylene ether);
a crosslinked styrenic block copolymer; and
a non-polyolefin crystalline or semi-crystalline resin.

2. The composition of claim 1, wherein the non-polyolefin crystalline or semi-crystalline resin is selected from the group consisting of a polyamide and a polyester.

3. The composition of claim 1, wherein the crosslinked styrenic block copolymer is a partially crosslinked styrenic block copolymer.

4. The composition of claim 1, wherein the crosslinked styrenic block copolymer comprises (A) at least one block derived from an alkenyl aromatic monomer and (B) at least one block derived from a conjugated diene.

5. The composition of claim 1, wherein the crosslinked styrenic block copolymer is a blend obtained on melt-kneading an acid-functionalized block copolymer comprising (A) at least one block derived from an alkenyl aromatic monomer and (B) at least one block derived from a conjugated diene; and a crosslinking agent.

6. The composition of claim 5, wherein the crosslinking agent is selected from the group consisting of an amine crosslinking compound and peroxide compound.

7. The composition of claim 6, wherein the crosslinking agent is the amine crosslinking compound; and wherein the amine crosslinking compound is an aliphatic polyamine crosslinking agent selected from the group consisting of polyethylenimine, hexamethylenediamine, aminosilane, and tetramethylenepentamine.

8. The composition of claim 5, wherein the acid-functionalized block copolymer is a product of functionalizing an unhydrogenated or hydrogenated styrenic block copolymer comprising (A) at least one block derived from an alkenyl aromatic monomer and (B) at least one block derived from a conjugated diene with an acid functionalizing agent selected from the group consisting of maleic acid, maleic anhydride, methyl maleic acid, methyl maleic anhydride, dimethyl maleic acid, dimethyl maleic anhydride, monochloro maleic acid, monochloro maleic anhydride, dichloro maleic acid, dichloro maleic anhydride, 5-norbornene-2,3-dicarboxylic acids, 5-norbornene-2,3-dicarboxylic acid anhydrides, tetrahydrophthalic acids, tetrahydrophthalic anhydrides, fumaric acid, itaconic acid, itaconic anhydride, citraconic acid, citraconic anhydride, trimellitic acid, trimellitic acid anhydride, trimellitic anhydride acid chloride, and mixtures thereof.

9. The composition of claim 4, wherein the alkenyl aromatic compound providing the block (A) is represented by formula: 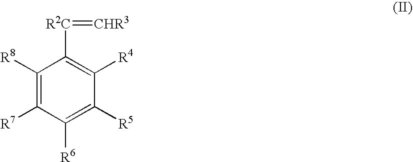
wherein R² and R³ each independently represent a hydrogen atom, a C₁-C₈ allyl group, or a C₂-C₈ alkenyl group; R⁴ and R⁸ each independently represent a hydrogen atom, or a C₁-C₈ allyl group; and R⁵-R⁷ each independently represent a hydrogen atom, a C₁-C₈ allyl group, or a C₂-C₈ alkenyl group, or R⁴ and R⁵ are taken together with the central aromatic ring to form a naphthyl group, or R⁵ and R⁶ are taken together with the central aromatic ring to form a naphthyl group.

10. The composition of claim 8, wherein the acid-functionalized block copolymer is a maleic anhydride or fumaric acid-functionalized linear block copolymer or radial teleblock copolymer of styrene and a conjugated diene selected from the group consisting of butadiene, isoprene, and mixtures thereof; wherein the acid-functionalized block copolymer has a styrene content of about 10 to about 60 parts by weight.

11. The composition of claim 10, wherein the acid-functionalized block copolymer is a maleic anhydride-functionalized polystyrene-poly(ethylene-butylene)-polystyrene triblock copolymer having a styrene content of about 10 to about 50 parts by weight, or a maleic anhydride-functionalized polystyrene-poly(ethylene-butylene) diblock copolymer having a styrene content of about 10 to about 60 parts by weight.

12. The composition of claim 1, wherein the poly(arylene ether) comprises repeating structural units having the formula 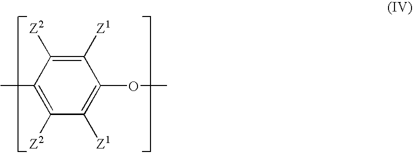
wherein for each structural unit, each Z¹ and Z² is independently hydrogen, halogen, primary or secondary lower alkyl, phenyl, haloalkyl, aminoalkyl, alkenylalkyl, alkynylalkyl, hydrocarbonoxy, aryl, or halohydrocarbonoxy wherein at least two carbon atoms separate the halogen and oxygen atoms.

13. The composition according to claim 12, wherein the poly(arylene ether) comprises 2,6-dimethyl-1,4-phenylene ether units, 2,3,6-trimethyl-1,4-phenylene ether units, or a combination thereof.

14. The composition of claim 2, wherein the non-polyolefin crystalline or semi-crystalline resin is a polyamide selected from the group consisting of nylon-6, nylon-6,6, nylon-4,6, nylon-12, nylon-6,10, nylon 6,9, nylon 6/6T, and nylon 6,6/6T.

15. The composition of claim 2, wherein the non-polyolefin crystalline or semi-crystalline resin is a polyester comprising repeating units of the following general formula: 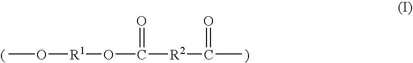
wherein R¹ is the residue of an aryl, alkane, or cycloalkane-containing diol, or chemical equivalent thereof, and R² is the decarboxylated residue derived from an aryl, aliphatic, or cycloalkane containing diacid or chemical equivalent thereof.

16. The composition of claim 15, wherein the polyester is selected from the group consisting of poly(ethylene terephthalate) (PET), poly(1,4-butylene terephthalate) (PBT), and poly(propylene terephthalate) (PPT).

17. The composition of claim 1, further comprising a compatibilizing agent.

18. The composition of claim 17, wherein the compatibilizing agent is selected from the group consisting of liquid diene polymers, epoxy compounds, oxidized polyolefin wax, quinones, organosilane compounds, polyfunctional compounds, and poly(arylene ethers) functionalized by the above compatibilizing agents.

19. The composition of claim 17, wherein the compatibilizing agent is selected from the group consisting of citric acid, malic acid, maleic acid, maleic anhydride, fumaric acid, and combinations comprising at least one of the foregoing compatibilizing agents.

20. The composition of claim 17, comprising a compatibilized poly(arylene ether)/non-polyolefin crystalline or semi-crystalline resin.

21. The composition of claim 1, further comprising an additive selected from a group consisting of stabilizers, mold release agents, processing aids, flame retardants, drip retardants, nucleating agents, UV blockers, dyes, pigments, antioxidants, anti-static agents, blowing agents, mineral oil, metal deactivators, antiblocking agents, and combinations thereof.

22. The composition of claim 1, wherein the composition comprises a continuous phase and a dispersed phase.

23. The composition of claim 22, wherein the continuous phase comprises the non-polyolefin crystalline or semi-crystalline resin, and the dispersed phase comprises the poly(arylene ether); and wherein the crosslinked styrenic block copolymer is micro-dispersed in the continuous phase, the dispersed phase, or both of them.

24. The composition of claim 1, comprising
5 to 60 parts by weight of the crosslinked styrenic block copolymer;
to 65 parts by weight of the poly(arylene ether); and
to 95 parts by weight of the non-polyolefin crystalline or semi-crystalline resin;
wherein all parts by weight are based on 100 parts by weight total of the poly(arylene ether) and the non-polyolefin crystalline or semi-crystalline resin.

25. The composition of claim 24, comprising 5 to 40 parts by weight of the crosslinked styrenic block copolymer.

26. The composition of claim 25, comprising 10 to 40 parts by weight of the poly(arylene ether).

27. The composition of claim 26, comprising 35 to 60 parts by weight of the non-polyolefin crystalline or semi-crystalline resin.

28. The composition of claim 1, comprising
5 to 60 parts by weight of the crosslinked styrenic block copolymer comprising a blend obtained on melt-kneading a maleic anhydride-functionalized linear block copolymer or radial teleblock copolymer of styrene and a conjugated diene selected from the group consisting of butadiene, isoprene, and mixtures thereof; and a crosslinking agent comprising a polyethylenimine;
5 to 65 parts by weight of the poly(arylene ether) comprising 2,6-dimethyl-1,4-phenylene ether units, 2,3,6-trimethyl-1,4-phenylene ether units, or a combination thereof; and
35 to 95 parts by weight of the non-polyolefin crystalline or semi-crystalline resin comprising nylon-6, nylon-6,6, PET, PPT, PBT or a combination thereof;
wherein all parts by weight are based on 100 parts by weight total of the poly(arylene ether) and the non-polyolefin crystalline or semi-crystalline resin.

29. A thermoplastic composition comprising a continuous phase comprising a non-polyolefin crystalline or semi-crystalline resin; and a dispersed phase comprising a crosslinked styrenic block copolymer.

30. The composition of claim 29, wherein the composition further comprises a poly(arylene ether).

31. The composition of claim 30, wherein the composition comprises a dispersed phase comprising the poly(arylene ether); wherein the crosslinked styrenic block copolymer is micro-dispersed in the continuous phase, the dispersed phase, or both of them.

32. The composition of claim 31, wherein the composition further comprises a compatibilizing agent.

33. The composition of claim 29, wherein the crosslinked styrenic block copolymer is a blend obtained on melt-kneading an acid-functionalized block copolymer comprising (A) at least one block derived from an alkenyl aromatic monomer and (B) at least one block derived from a conjugated diene; and a crosslinking agent.

34. The composition of claim 33, wherein the acid-functionalized block copolymer is a product of functionalizing an unhydrogenated or hydrogenated styrenic block copolymer comprising (A) at least one block derived from an alkenyl aromatic monomer and (B) at least one block derived from a conjugated diene with acid functionalizing agent selected from the group consisting of maleic acid, maleic anhydride, methyl maleic acid, methyl maleic anhydride, dimethyl maleic acid, dimethyl maleic anhydride, monochloro maleic acid, monochloro maleic anhydride, dichloro maleic acid, dichloro maleic anhydride, 5-norbornene-2,3-dicarboxylic acids, 5-norbornene-2,3-dicarboxylic acid anhydrides, tetrahydrophthalic acids, tetrahydrophthalic anhydrides, fumaric acid, itaconic acid, itaconic anhydride, citraconic acid, citraconic anhydride, trimellitic acid, trimellitic acid anhydride, trimellitic anhydride acid chloride, and mixtures thereof.

35. The composition of claim 33, wherein the crosslinking agent is selected from the group consisting of an amine crosslinking compound and a peroxide compound.

36. The composition of claim 35, wherein the crosslinking agent is the amine crosslinking compound; and wherein the amine crosslinking compound is an aliphatic polyamine crosslinking agent selected from the group consisting of polyethylenimine, hexamethylenediamine, aminosilane, and tetramethylenepentamine.

37. The composition of claim 29, wherein the crosslinked styrenic block copolymer is a partially crosslinked styrenic block copolymer.

38. A method of preparing a composition according to claim 1, comprising melt-kneading a crosslinked styrenic block copolymer; a poly(arylene ether); and a non-polyolefin crystalline or semi-crystalline resin.

39. The method of claim 38, comprising melt-kneading an acid functionalized styrenic block copolymer, a crosslinking agent, a poly(arylene ether), and a non-polyolefin crystalline or semi-crystalline resin.

40. The method of claim 39, comprising obtaining a masterbatch by melt-kneading an acid functionalized styrenic block copolymer, a crosslinking agent, and a part of poly(arylene ether); then blending the masterbatch with the remaining poly(arylene ether), the non-polyolefin crystalline or semicrystalline resin, and additional components if present.

41. The composition of claim 40, wherein the crosslinking agent is selected from the group consisting of an amine crosslinking compound, a peroxide compound, or a combination thereof.

42. The method of claim 41, comprising obtaining a masterbatch by melt-kneading an acid-functionalized styrenic block copolymer comprising (A) at least one block derived from an alkenyl aromatic monomer and (B) at least one block derived from a conjugated diene, an amine crosslinking compound, and a part of poly(arylene ether); then blending the masterbatch with the remaining poly(arylene ether), the non-polyolefin crystalline or semicrystalline resin, and additional components if present.

43. The method according to claim 40, wherein the acid functionalized styrenic block copolymer is obtained by functionalizing a styrenic block copolymer comprising (A) at least one block derived from an alkenyl aromatic monomer and (B) at least one block derived from a conjugated diene with maleic anhydride or fumaric acid, optionally in the presence of a peroxide.

44. An article comprising a thermoplastic composition comprising a continuous phase comprising a non-polyolefin crystalline or semi-crystalline resin; and a dispersed phased phase comprising a crosslinked styrenic block copolymer.

45. An article comprising a thermoplastic composition comprising a poly(arylene ether); a crosslinked styrenic block copolymer; and a non-polyolefin crystalline or semi-crystalline resin.

46. An article comprising a film, sheet, molded object, or composite, wherein the film, sheet, molded object or composite comprises at least one layer comprising the composition of claim 1 or 29.
